(19) United States
(12) Patent Application Publication
(10) Pub. No.: US 2013/0040814 A1
(43) Pub. Date: Feb. 14, 2013

(54) HERBICIDAL COMPOSITION

(71) Applicant: Ryu Yamada, Kusatsu-shi (JP)

(72) Inventor: Ryu Yamada, Kusatsu-shi (JP)

(73) Assignee: ISHIHARA SANGYO KAISHA, LTD., Osaka (JP)

(21) Appl. No.: 13/641,724

(22) PCT Filed: May 2, 2011
(86) PCT No.: PCT/JP2011/060540

§ 371 Date: Oct. 17, 2012

(30) Foreign Application Priority Data
May 6, 2010 (JP) 2010-106498

(51) Int. Cl. A01N 43/54; A01N 47/28; A01P 13/00; A01N 47/40

(52) U.S. Cl. 504/136; 504/141; 504/148

(57) ABSTRACT

A herbicidal composition having a broad herbicidal spectrum and having high activities and long residual effects, is provided. A herbicidal composition comprising the following compound A and the following compound B:
Compound A: at least one sulfonylurea compound selected from the group consisting of flazasulfuron and trifloxysulfuron, or its salt,
Compound B: at least one benzonitrile compound selected from the group consisting of chlorthiamid and dichlobenil, or its salt.

### TECHNICAL FIELD

The present invention relates to a herbicidal composition comprising at least one sulfonylurea compound selected from the group consisting of flazasulfuron and trifloxysulfuron, or its salt, and at least one benzonitrile compound selected from the group consisting of chlorthiamid and dichlobenil, or its salt.

### BACKGROUND ART

Various herbicidal compositions have been studied to control undesired plants (hereinafter simply referred to as weeds) in agricultural fields and non-crop land. For example, Patent Document 1 discloses a herbicidal composition comprising a sulfonylurea herbicide such as halosulfuron, cyclosulfamuron, ethoxysulfuron or imazosulfuron, and dichlobenil or chlorthiamid, as active ingredients. However, there is no specific disclosure about a herbicidal composition comprising at least one sulfonylurea compound selected from the group consisting of flazasulfuron and trifloxysulfuron, or its salt, and at least one benzonitrile compound selected from the group consisting of chlorthiamid and dichlobenil, or its salt.

### PRIOR ART DOCUMENT

### Patent Document

Patent Document 1: JP-A-2009-57310

### DISCLOSURE OF INVENTION

### Technical Problem

At present, many herbicidal compositions have been developed and used, but there are a variety of types of weeds to be controlled, and their development lasts for a long period of time. Thus, a herbicidal composition having a broad herbicidal spectrum and having high activities and long residual effects has been desired. Further, there are cases where weeds having sensitivity decreased against conventional herbicidal compositions become problematic.

It is an object of the present invention to provide a herbicidal composition having a broad herbicidal spectrum and having high activities and long residual effects.

### Solution to Problem

According to the present invention, it is possible to provide a herbicidal composition having a broad herbicidal spectrum and having high activities and long residual effects, by combining the following compounds A and B.

That is, the present invention provides the following (1) to (12).

(1) A herbicidal composition comprising the following compound A and the following compound B:

Compound A: at least one sulfonylurea compound selected from the group consisting of flazasulfuron and trifloxysulfuron, or its salt,

Compound B: at least one benzonitrile compound selected from the group consisting of chlorthiamid and dichlobenil, or its salt.

(2) The herbicidal composition according to the above (1), wherein the mixing ratio of compound A to compound B is from 1:1.25 to 1:1,000 by weight ratio.
(3) The herbicidal composition according to the above (1), wherein compound A is flazasulfuron or its salt.
(4) The herbicidal composition according to the above (1), wherein compound B is chlorthiamid or its salt.
(5) The herbicidal composition according to the above (1), wherein compound A is flazasulfuron or its salt, and compound B is chlorthiamid or its salt.
(6) A method for controlling undesired plants or inhibiting their growth, which comprises applying a herbicidally effective amount of a herbicidal composition comprising the following compound A and the following compound B to the undesired plants or to a place where they grow:

Compound A: at least one sulfonylurea compound selected from the group consisting of flazasulfuron and trifloxysulfuron, or its salt,

Compound B: at least one benzonitrile compound selected from the group consisting of chlorthiamid and dichlobenil, or its salt.

(7) A method for controlling undesired plants or inhibiting their growth, which comprises applying a herbicidally effective amount of the following compound A and a herbicidally effective amount of the following compound B to the undesired plants or to a place where they grow:

Compound A: at least one sulfonylurea compound selected from the group consisting of flazasulfuron and trifloxysulfuron, or its salt,

Compound B: at least one benzonitrile compound selected from the group consisting of chlorthiamid and dichlobenil, or its salt.

(8) The method according to the above (6) or (7), wherein the dose of compound A is from 10 to 200 g/ha, and the dose of compound B is from 500 to 10,000 g/ha.
(9) The method according to the above (6) or (7), wherein the undesired plants are perennial cyperaceae in lawns.
(10) The method according to the above (6) or (7), wherein compound A is flazasulfuron or its salt.
(11) The method according to the above (6) or (7), wherein compound B is chlorthiamid or its salt.
(12) The method according to the above (6) or (7), wherein compound A is flazasulfuron or its salt, and compound B is chlorthiamid or its salt.

### Advantageous Effects of Invention

According to the present invention, it is possible to provide a herbicidal composition having a broad herbicidal spectrum and having high activities and long residual effects, whereby the dose of the herbicidal components can be reduced. Further, it is also possible to control weeds having sensitivity decreased against conventional herbicidal compositions.

When the herbicidal activity in a case where two active ingredients are combined, is larger than the simple sum (the expected activity) of the respective herbicidal activities of the two active ingredients, it is called a synergistic effect. The activity expected by the combination of two active ingredients can be calculated as follows (Colby S. R., “Weed”, vol. 15, p. 20-22, 1967).

E=α+β−(α×β÷100)

where

α: growth inhibition rate when treated with x (g/ha) of herbicide X,

β: growth inhibition rate when treated with y (g/ha) of herbicide Y,

E: growth inhibition rate expected when treated with x (g/ha) of herbicide X and y (g/ha) of herbicide Y.

That is, when the actual growth inhibition rate (measured value) is larger than the growth inhibition rate by the above calculation (calculated value), the activity by the combination can be regarded as showing a synergistic effect. The herbicidal composition of the present invention shows a synergistic effect when calculated by the above formula.

### DESCRIPTION OF EMBODIMENTS

As compound A, flazasulfuron (common name) being a sulfonyl urea compound is 1-(4,6-dimethoxypyrimidin-2-yl)-3-(3-trifluoromethyl-2-pyridylsulfonyl)urea, and trifloxysulfuron (common name) is 1-(4,6-dimethoxypyrimidin-2-yl)-3-[3-(2,2,2-trifluoroethoxy)-2-pyridylsulfonyl]urea. As compound A, flazasulfuron being a sulfonyl urea compound is preferred.

As compound B, chlorthiamid (common name) being a benzonitrile compound is 2,6-dichlorothiobenzamide, and dichlobenil (common name) is 2,6-dichlorobenzonitrile. As compound B, chlorthiamid being a benzonitrile compound is preferred.

The salt included in compound A and compound B may be any salt so long as it is agriculturally acceptable. Examples thereof include alkali metal salts such as a sodium salt and a potassium salt; alkaline earth metal salts such as a magnesium salt and a calcium salt; ammonium salts such as a monomethylammonium salt, a dimethylammonium salt and a triethylammonium salt; inorganic acid salts such as a hydrochloride, a perchlorate, a sulfate and a nitrate, and organic acid salts such as an acetate and a methanesulfonate.

The salt included in compound A or compound B is preferably an alkali metal salt or the like, particularly preferably a sodium salt.

The mixing ratio of compound A to compound B cannot generally be defined, as it varies depending upon various conditions such as the type of the formulation, the weather conditions, and the type and the growth stage of the weeds to be controlled, but it is, for example, from 1:1.25 to 1:1,000, preferably from 1:5 to 1:500, more preferably from 1:66 to 1:320, particularly preferably from 1:80 to 1:240, by weight ratio.

The dose of compound A and compound B cannot generally be defined, as it varies depending upon various conditions such as the mixing ratio of compound A to compound B, the type of the formulation, the weather conditions, and the type and the growth stage of the weeds to be controlled. However, for example, compound A is applied in an amount of from 10 to 200 g/ha, preferably from 20 to 100 g/ha, more preferably from 25 to 75 g/ha, particularly preferably from 33 to 62.5 g/ha, and compound B is applied in an amount of from 250 to 10,000 g/ha, preferably from 500 to 10,000 g/ha, more preferably from 5,000 to 8,000 g/ha, particularly preferably from 5,000 to 8,000 g/ha.

The herbicidal composition of the present invention may be applied to weeds or may be applied to a place where they grow. Further, it may be applied at any time either before or after the emergence of the weeds. Further, the herbicidal composition of the present invention may take various application forms such as soil application, foliar application, irrigation application, and submerged application. Further, the herbicidal composition can be applied to agricultural fields such as upland fields, orchards and paddy fields, and non-cropland such as ridges of fields, fallow fields, play grounds, golf course, vacant land, forests, factory sites, railway sides and roadsides.

The herbicidal composition of the present invention can control a broad range of weeds such as annual weeds and perennial weeds. The weeds to be controlled by the herbicidal composition of the present invention may, for example, be cyperaceae such as green kyllinga (Cyperus brevifolia var. leiolepis), purple nutsedge (Cyperus rotundus L.), and amur cyperus (Cyperus microiria Steud.); gramineae such as barnyardgrass (Echinochloa crus-galli L., Echinochloa oryzicola vasing.), crabgrass (Digitaria sanguinalis L., Digitaria ischaemum Muhl., Digitaria adscendens Henr., Digitaria microbachne Henr., Digitaria horizontalis Willd.), green foxtail (Setaria viridis L.), goosegrass (Eleusine indica L.), wild oat (Avena fatua L.), johnsongrass (Sorghum halepense L.), quackgrass (Agropyron repens L.) and annual bluegrass (Poa annua L.); scrophulariaceae such as persian speedwell (Veronica persica Poir.), and corn speedwell (Veronica arvensis L.); compositae such as purple cudweed (Gnaphalium spicatum Lam.), jersey cudweed (Gnaphalium affine D.DON), hairy fleabane (Conyza bonariensis (L.) Cronq.), horseweed (Erigeron canadensis L.), dandelion (Taraxacum officinale Weber), and common cocklebur (Xanthium strumarium L.); leguminosae such as white clover (Trifolium repens L.), black medic (Medicago lupulina L.), and tiny vetch (Vicia hirsuta (L.) S. F. Gray); caryophyllaceae such as sticky chickweed (Cerastium glomeratum Thuill.), and common chickweed (Stellaria media L.); euphorbiaceae such as prostrate spurge (Euphorbia supina Raf.) and threeseeded copperleaf (Acalypha australis L.); plantaginaceae such as asiatic plantain (Plantago asiatica L.); oxalidaceae such as creeping woodsorrel (Oxalis corniculata L.); apiaceae such as lawn pennywort (Hydrocotyle sibthorpioides Lam.); violaceae such as violet (Viola mandshurica W. Becker); iridaceae such as blue-eyedgrass (Sisyrinchium rosulatum Bicknell); geraniaceae such as carolina geranium (Geranium carolinianum L.); labiatae such as purple deadnettle (Lamium purpureum L.), and henbit (Lamium amplexicaule L.); malvaceae such as velvetleaf (Abutilon theophrasti MEDIC.), and prickly sida (Sida spinosa L.); convolvulaceae such as tall morningglory (Ipomoea purpurea L.); chenopodiaceae such as common lambsquarters (Chenopodium album L.); portulacaceae such as common purslane (Portulaca oleracea L.); amaranthaceae such as redroot pigweed (Amaranthus retroflexus L.); solanaceae such as black nightshade (Solanum nigrum L.); polygonaceeae such as spotted knotweed (Polygonum lapathifolium L.), and green smartweed (Polygonum scabrum MOENCH); and cruciferae such as flexuous bittercress (Cardamine flexuosa WITH.).

The herbicidal composition of the present invention exhibits excellent effects, for example, for controlling weeds in lawns or inhibiting their growth. Particularly, it is suitable for controlling cyperaceae such as green kyllinga, purple nutsedge, amur cyperus, etc. Among them, it is particularly suitable for controlling perennial cvperaceae such as green kyllinga, purple nutsedge, etc. Further, the herbicidal composition of the present invention exhibits excellent effects also for controlling weeds having sensitivity decreased against a sulfonylurea compound such as flazasulfuron or trifloxysulfuron (hereinafter referred to simply as weeds having sensitivity decreased) or inhibiting their growth. As one example of a weed having sensitivity decreased, green kyllinga may, for example, be mentioned. Further, the herbicidal composition of the present invention may exhibit excellent effects for controlling not only green kyllinga having sensitivity decreased but also other weeds having sensitivity decreased or inhibiting their growth.

The herbicidal composition of the present invention may further be used as mixed with other herbicidal compounds, whereby the spectrum of weeds to be controlled, the application timing, the herbicidal activity, etc. may be improved to preferred directions in some cases. Such other herbicidal ingredients (common names) may, for example, be asulam, triclopyr, 2,4-D, MCPA, mecoprop, flupoxam, sulfentrazone, halosulfuron, penoxsulam, fluazifop, indanofan, dithiopyr, oxaziclomefone, pendimethalin, etc. In a case where salts, alkyl esters, hydrates, different crystal forms, various structural isomers, etc. of these compounds exist, they are, of course, all included, even when not specifically mentioned.

The herbicidal composition of the present invention may be prepared by mixing compound A and compound B, as active ingredients, with various agricultural additives in accordance with conventional formulation methods for agricultural chemicals, and applied in various formulations such as dusts, granules, water dispersible granules, wettable powders, tablets, pills, capsules (including a formulation packaged by a water soluble film), water-based suspensions, oil-based suspensions, microemulsions, suspoemulsions, water soluble powders, emulsifiable concentrates, soluble concentrates or pastes. It may be formed into any formulation which is commonly used in this field, so long as the object of the present invention is thereby met.

At the time of the formulation, compound A and compound B may be mixed together for the formulation, or they may be separately formulated.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used. The mix ratio by weight of the active ingredient to such various additives may be from 0.001:99.999 to 95:5, preferably from 0.005:99.995 to 90:10.

As a method of applying the herbicidal composition of the present invention, a proper method can be employed among various methods depending upon various conditions such as the application site, the type of the formulation, the type of the weeds to be controlled, and the growth stage of the weeds to be controlled, and for example, the following methods may be mentioned.

1. Compound A and compound B are formulated together, and the formulation is applied as it is.

2. Compound A and compound B are formulated together, the formulation is diluted to a predetermined concentration with e.g. water, and as the case requires, a spreader (such as a surfactant, a vegetable oil or a mineral oil) is added for application.

3. Compound A and compound B are separately formulated and applied as they are.

4. Compound A and compound B are separately formulated, and they are diluted to a predetermined concentration with e.g. water, and as the case requires, a spreader (such as a surfactant, a vegetable oil or a mineral oil) is added for application.

5. Compound A and compound B are separately formulated, and the formulations are mixed when diluted to a predetermined concentration with e.g. water, and as the case requires, a spreader (such as a surfactant, a vegetable oil or a mineral oil) is added for application.

Preferred embodiments of the present invention will be described below, but the present invention is by no means restricted thereto.

(1) A herbicidal composition comprising flazasulfuron or its salt, and compound B.
(2) A herbicidal composition comprising flazasulfuron or its salt, and compound B in a mixing ratio of from 1:10 to 1:300 by weight ratio.
(3) A herbicidal composition comprising flazasulfuron or its salt, and compound B in a mixing ratio of from 1:80 to 1:300 by weight ratio.
(4) A herbicidal composition comprising flazasulfuron or its salt, and compound B in a mixing ratio of from 1:80 to 1:240 by weight ratio.
(5) A herbicidal composition comprising trifloxysulfuron or its salt, and compound B.
(6) A herbicidal composition comprising trifloxysulfuron or its salt, and compound B in a mixing ratio of from 1:5 to 1:1,000 by weight ratio.
(7) A herbicidal composition comprising trifloxysulfuron or its salt, and compound B in a mixing ratio of from 1:100 to 1:1,000 by weight ratio.
(8) The herbicidal composition according to any one of the above (1) to (7), wherein compound B is chlorthiamid or its salt.
(9) The herbicidal composition according to any one of the above (1) to (7), wherein compound B is dichlobenil or its salt.
(10) A method for controlling undesired plants or inhibiting their growth, which comprises applying from 25 to 100 g/ha of flazasulfuron or its salt and from 1,000 to 8,000 g/ha of compound B to the undesired plants or to a place where they grow.
(11) A method for controlling undesired plants or inhibiting their growth, which comprises applying from 25 to 62.5 g/ha of flazasulfuron or its salt and from 5,000 to 8,000 g/ha of compound B to the undesired plants or to a place where they grow.
(12) A method for controlling undesired plants or inhibiting their growth, which comprises applying from 33 to 62.5 g/ha of flazasulfuron or its salt and from 5,000 to 8,000 g/ha of compound (B) to the undesired plants or to a place where they grow.
(13) A method for controlling undesired plants or inhibiting their growth, which comprises applying from 10 to 100 g/ha of trifloxysulfuron or its salt and from 500 to 10,000 g/ha of compound B to the undesired plants or to a place where they grow.
(14) A method for controlling undesired plants or inhibiting their growth, which comprises applying from 10 to 50 g/ha of trifloxysulfuron or its salt and from 5,000 to 10,000 g/ha of compound B to the undesired plants or to a place where they grow.
(15) The method according to any one of the above (10) to (14), wherein compound B is chlorthiamid or its salt.
(16) The method according to any one of the above (10) to (14), wherein compound (B) is dichlobenil or its salt.

### EXAMPLES

Now, the present invention will be described in detail with reference to Examples. However, it should be understood that the present invention is by no means restricted to such specific Examples.

### Test Example 1

Upland field soil was put into a 1/1,000,000 ha pot, and tubers of purple nutsedge (Cyperus rofundus L.) were planted. 33 days later, when purple nutsedge reached a 6 to 7 leaf stage, a predetermined amount of water dispersible granules containing flazasulfuron as an active ingredient (tradename: SHIBAGEN DF, manufactured by Ishihara Sangyo Kaisha, Ltd.) was diluted with water (corresponding to 200 L/ha) containing 0.02 vol % of an agricultural adjuvant (tradename: Kusa-rino, manufactured by Nihon Nohyaku Co., Ltd.) and applied by foliar application by means of a small sprayer, and a predetermined amount of granules containing chlorthiamid as an active ingredient (tradename: GF Ben-pole granules, manufactured by Suimitomo Chemical Garden Products Inc.) was applied by granule application.

On the 36th day after application, the state of growth of purple nutsedge was visually observed and evaluated in accordance with the following standard. The measured values of the growth inhibition rate (%) (evaluated values by visual observation) and the calculated values obtained by the Colby's formula are shown in Table 1.

Measured value of growth inhibition rate(%)(evaluated value by visual observation)=0(equivalent to non-treated area) to 100(complete kill)

That is, the measured value of growth inhibition rate (%) was rated to be 0% in a case where the level of the growth inhibition of weeds was the same in the non-treated area and to be 100% in a case where the growth was completed inhibited and the weeds were killed.

TABLE 1

| | | Growth inhibition rate (%) | |
|---|---|---|---|
| Active | Dose | of purple nutsedge | |
| ingredient | (g/ha) | Measured value | Calculated value |
| Flazasulfuron | 25 | 18 | — |
| | 50 | 73 | — |
| Chlorthiamid | 1,000 | 35 | — |
| | 2,000 | 33 | — |
| | 4,000 | 50 | — |
| | 6,000 | 69 | — |
| Flazasulfuron + | 25 + 2,000 | 69 | 45 |
| Chlorthiamid | 25 + 4,000 | 94 | 59 |
| | 25 + 6,000 | 95 | 75 |
| | 50 + 1,000 | 87 | 82 |
| | 50 + 2,000 | 93 | 82 |
| | 50 + 4,000 | 98 | 87 |
| | 50 + 6,000 | 100 | 92 |

### Test Example 2

Upland field soil was put into a 1/1,000,000 ha pot, and rhizomes of green kyllinga (Kyllinga brevifolia var. leiolepis) were planted. 46 days later, when the height of green kyllinga reached 4 to 7 cm, a predetermined amount of SHIBAGEN DF, (tradename) and a predetermined amount of GF Ben-pole (tradename) were applied in the same manner as in Test Example 1.

On the 54th day after application, the state of growth of green kyllinga was visually observed, and in the same manner as in Test Example 1, the measured growth inhibition rate (%) and the calculated growth inhibition rate (%) obtained by the Colby's formula are shown in Table 2.

TABLE 2

| | | Growth inhibition rate (%) | |
|---|---|---|---|
| Active | Dose | of green kyllinga | |
| ingredient | (g/ha) | Measured value | Calculated value |
| Flazasulfuron | 50 | 80 | — |
| Chlorthiamid | 1,000 | 20 | — |
| | 5,000 | 65 | — |
| Flazasulfuron + | 50 + 1,000 | 88 | 84 |
| Chlorthiamid | 50 + 5,000 | 98 | 93 |

### Test Example 3

Upland field soil was put into a 1/1,000,000 ha pot, and tubers of purple nutsedge (Cyperus rofundus L) were planted. 54 days later, when purple nutsedge reached a height of 25 to 30 cm, a predetermined amount of a herbicidal composition was diluted with water (corresponding to 200 L/ha) containing 0.02 vol % of an agricultural adjuvant (tradename: Kusa-rino, manufactured by Nihon Nohyaku Co., Ltd.) and applied by foliar application by means of a small sprayer.

On the 42nd day after application, the state of growth of the plant was visually observed, and in the same manner as in Test Example 1, the measured growth inhibition rate (%) and the calculated growth inhibition rate (%) obtained by the Colby's formula are shown in Table 3.

TABLE 3

| | | Growth inhibition rate (%) | |
|---|---|---|---|
| Active | Dose | of purple nutsedge | |
| ingredient | (g/ha) | Measured value | Calculated value |
| Flazasulfuron | 25 | 87 | — |
| | 50 | 98 | — |
| Chlorthiamid | 500 | 0 | — |
| | 1,000 | 0 | — |
| | 2,000 | 18 | — |
| | 4,000 | 33 | — |
| Dichlobenil | 500 | 10 | — |
| | 1,000 | 23 | — |
| | 2,000 | 10 | — |
| | 4,000 | 33 | — |
| Flazasulfuron + | 25 + 500 | 97 | 87 |
| Chlorthiamid | 25 + 1,000 | 100 | 87 |
| | 25 + 2,000 | 99 | 89 |
| | 25 + 4,000 | 100 | 91 |
| | 50 + 500 | 99 | 98 |
| | 50 + 1,000 | 100 | 98 |
| | 50 + 2,000 | 99 | 98 |
| | 50 + 4,000 | 100 | 99 |
| Flazasulfuron + | 25 + 500 | 98 | 88 |
| Dichlobenil | 25 + 1,000 | 99 | 90 |
| | 25 + 2,000 | 100 | 88 |
| | 25 + 4,000 | 99 | 91 |
| | 50 + 500 | 100 | 98 |
| | 50 + 1,000 | 99 | 98 |
| | 50 + 2,000 | 100 | 98 |
| | 50 + 4,000 | 100 | 99 |

### Test Example 4

Upland field soil was put into a 1/1,000,000 ha pot, and tubers of purple nutsedge were planted. When purple nutsedge reached a 13 leaf stage, a predetermined amount of SHIBAGEN DF (tradename) and a predetermined amount of a wettable powder containing dichlobenil as an active ingredient (tradename: Kasoron wettable powder, manufactured by AGRO-KANESHO Co., Ltd.) were diluted with water (corresponding to 2,000 L/ha) containing 0.02 vol % of Kusa-rino (tradename) and applied by foliar application by means of a small sprayer.

On the 42nd day after application, the state of growth of purple nutsedge was visually observed, and in the same manner as in Test Example 1, the measured growth inhibition rate (%) and the calculated growth inhibition rate (%) obtained by the Colby's formula are shown in Table 4.

TABLE 4

| | | Growth inhibition rate (%) | |
|---|---|---|---|
| | Dose | of Purple nutsedge | |
| Compound | (g/ha) | Measured value | Calculated value |
| Flazasulfuron | 25 | 87 | — |
| Dichlobenil | 500 | 10 | — |
| | 4,000 | 33 | — |
| Flazasulfuron + | 25 + 500 | 98 | 88 |
| Dichlobenil | 25 + 4,000 | 99 | 91 |

### Test Example 5

Upland field soil was put into a 1/1,000,000 ha pot, rhizomes of green kyllinga (Kyllinga brevifolia var. leiolepis) were planted. When the height of green kyllinga reached 6 to 8 cm, a predetermined amount of water dispersible granules containing a sodium salt of trifloxysulfuron as an active ingredient (tradename: Monument water dispersible granules, manufactured by Syngenta Japan) and a predetermined amount of chlorthiamid (reagent, manufactured by Wako Pure Chemical Industries, Ltd.) were applied in the same manner as in Test Example 4.

On the 42nd day after application, the state of growth of green kyllinga was visually observed, and in the same manner as in Test Example 1, the measured growth inhibition rate (%) and the calculated growth inhibition rate (%) obtained by the Colby's formula are shown in Table 5.

TABLE 5

| | | Growth inhibition rate (%) | |
|---|---|---|---|
| | Dose | of green kyllinga | |
| Compound | (g/ha) | Measured value | Calculated value |
| Sodium salt of | 10 | 0 | — |
| trifloxysulfuron | 200 | 25 | — |
| Chlorthiamid | 1,000 | 18 | — |
| | 10,000 | 30 | — |
| Sodium salt of | 10 + 10,000 | 81 | 30 |
| trifloxysulfuron + | 200 + 1,000 | 74 | 39 |
| Chlorthiamid | | | |

### Test Example 6

Upland field soil was put into a 1/1,000,000 ha pot, rhizomes of green kyllinga (Kyllinga brevifolia var. leiolepis) were planted. When the height of green kyllinga reached 10 cm, a predetermined amount of Monument water dispersible granules (tradename) and a predetermined amount of chlorthiamid (reagent, manufactured by Wako Pure Chemical Industries, Ltd.) or Kasoron wet powder (tradename) were applied in the same manner as in Test Example 4.

On the 42nd day after application, the state of growth of green kyllinga was visually observed, and in the same manner as in Test Example 1, the measured growth inhibition rate (%) and the calculated growth inhibition rate (%) obtained by the Colby's formula are shown in Table 6.

TABLE 6

| | | Growth inhibition rate (%) | |
|---|---|---|---|
| | Dose | of green kyllinga | |
| Compound | (g/ha) | Measured value | Calculated value |
| Sodium salt of | 45 | 0 | — |
| trifloxysulfuron | | | |
| Chlorthiamid | 5,000 | 58 | — |
| Dichlobenil | 5,000 | 58 | — |
| Sodium salt of | 45 + 5,000 | 75 | 58 |
| trifloxysulfuron + | | | |
| Chlorthiamid | | | |
| Sodium salt of | 45 + 5,000 | 65 | 58 |
| trifloxysulfuron + | | | |
| Dichlobenil | | | |

### INDUSTRIAL APPLICABILITY

The herbicidal composition of the present invention has a broad herbicidal spectrum and has high activities and long residual effects, whereby it is possible to reduce the dose of the herbicidal components, and further it is capable of controlling weeds having sensitivity decreased against conventional herbicidal compositions and useful also for controlling perennial weeds.

The entire disclosure of Japanese Patent Application No. 2010-106498 filed on May 6, 2010 including specification, claims and summary is incorporated herein by reference in its entirety.

1. A herbicidal composition comprising the following compound A and the following compound B:
Compound A: at least one sulfonylurea compound selected from the group consisting of flazasulfuron and trifloxysulfuron, or its salt,
Compound B: at least one benzonitrile compound selected from the group consisting of chlorthiamid and dichlobenil, or its salt.

2. The herbicidal composition according to claim 1, wherein the mixing ratio of compound A to compound B is from 1:1.25 to 1:1,000 by weight ratio.

3. The herbicidal composition according to claim 1, wherein compound A is flazasulfuron or its salt.

4. The herbicidal composition according to claim 1, wherein compound B is chlorthiamid or its salt.

5. The herbicidal composition according to claim 1, wherein compound A is flazasulfuron or its salt, and compound B is chlorthiamid or its salt.

6. A method for controlling undesired plants or inhibiting their growth, which comprises applying a herbicidally effective amount of a herbicidal composition comprising the following compound A and the following compound B to the undesired plants or to a place where they grow:
Compound A: at least one sulfonylurea compound selected from the group consisting of flazasulfuron and trifloxysulfuron, or its salt,
Compound B: at least one benzonitrile compound selected from the group consisting of chlorthiamid and dichlobenil, or its salt.

7. A method for controlling undesired plants or inhibiting their growth, which comprises applying a herbicidally effective amount of the following compound A and a herbicidally effective amount of the following compound B to the undesired plants or to a place where they grow:
Compound A: at least one sulfonylurea compound selected from the group consisting of flazasulfuron and trifloxysulfuron, or its salt,
Compound B: at least one benzonitrile compound selected from the group consisting of chlorthiamid and dichlobenil, or its salt.

8. The method according to claim 6, wherein the dose of compound A is from 10 to 200 g/ha, and the dose of compound B is from 500 to 10,000 g/ha.

9. The method according to claim 6, wherein the undesired plants are perennial cyperaceae in lawns.

10. The method according to claim 6, wherein compound A is flazasulfuron or its salt.

11. The method according to claim 6, wherein compound B is chlorthiamid or its salt.

12. The method according to claim 6, wherein compound A is flazasulfuron or its salt, and compound B is chlorthiamid or its salt.

13. The method according to claim 7, wherein the dose of compound A is from 10 to 200 g/ha, and the dose of compound B is from 500 to 10,000 g/ha.

14. The method according to claim 7, wherein the undesired plants are perennial cyperaceae in lawns.

15. The method according to claim 7, wherein compound A is flazasulfuron or its salt.

16. The method according to claim 7, wherein compound B is chlorthiamid or its salt.

17. The method according to claim 7, wherein compound A is flazasulfuron or its salt, and compound B is chlorthiamid or its salt.
